(19) United States
(12) Patent Application Publication
(10) Pub. No.: US 2003/0018550 A1
(43) Pub. Date: Jan. 23, 2003

(54) Methods and systems for providing transaction data

(76) Inventors: Frank Lewis Rotman, Richmond, VA (US); Peter J. Wachtell, Boise, ID (US)

Correspondence Address: FINNEGAN, HENDERSON, FARABOW, GARRETT &, DUNNER LLP, 1300 I STREET, NW, WASHINGTON, DC, 20005, US

(21) Appl. No.: 09/788,643

(22) Filed: Feb. 21, 2001

Related U.S. Application Data
(60) Provisional application No. 60/183,757, filed on Feb. 22, 2000.

(51) Int. Cl. G06F 17/60

(52) U.S. Cl. 705/35

(57) ABSTRACT

A method for analyzing transactional payment data is shown. Transaction data, relating to a transaction between a payor and at least one of a plurality of payees is collected. The collected transaction data from a plurality of payors is normalized to create normalized data. The normalized data is scaled to create financial information. The financial information is provided to a user.

### RELATED APPLICATION DATA

The present application is related to and claims the benefit of U.S. Provisional Application No. 60/183,757, filed on Feb. 22, 2000, which is expressly incorporated herein by reference in its entirety.

### BACKGROUND OF THE INVENTION

1. Field of the Invention

The present invention relates to financial transaction data and systems and methods for using such data. More particularly, the invention relates to systems and methods for compiling financial transaction data and processing such data to provide financial information.

2. Description of the Related Art

Stock analysts, bank credit underwriters, government agencies like the Federal Reserve Bank and the IRS, and companies are interested in any available information about the flow of money as it relates to the potential prediction of future econometric parameters, such as the future direction of the market, the price of a particular stock, corporate revenue or earnings, credit ratings, or sales trends. For example, analysts attempt to use this information to assess the current health of a company as well as its potential future position in the marketplace. Through the assessment of a company's strategy and performance, stock analysts create an estimate of the “value” of a company, and ultimately what the company's stock will be worth in the future. Analysts can then either recommend the purchase or sale of a stock to clients or, in the case of a mutual fund analyst, take or unwind a position in the stock. Futures analysts are similarly inclined.

Unfortunately for the analysts, not much information is publicly available outside of monthly or quarterly announcements from a given company or quarterly announcements of commodity inventories from government agencies. News is generally shared quickly, but actual revenue, performance data, and inventory levels are only released on fixed dates throughout the year.

In today's marketplace, financial transactions are performed using various types of payment systems. Such payment systems include credit card systems and debit card systems. Payment systems for financial transactions also include check payment and clearing systems, wire transfer systems and the automated clearing house (“ACH”) system.

One example is the credit card. Credit cards, most commonly represented by plastic wallet-sized cards, are provided to customers by credit card issuers, which may be banks or other financial institutions. With a credit card, a customer can purchase products and services without an immediate exchange of cash. Instead, the customer incurs debt with each purchase. Thereafter, the customer repays the debt upon receipt of a periodic statement from the issuer. In many cases, a cardholder has the option to pay the outstanding balance in full or to defer at least a portion of the balance for later payment with accompanying interest or finance charges.

In addition to credit cards, there are cards that function like credit cards but are associated with a bank account, like a checking account. Transactions are cleared through a credit card clearinghouse like the Visa or MasterCard networks. These credit-card-like cards that are associated with a checking account are sometimes called check cards.

Additionally, debit cards may used to make payments in some situations. Debit cards are also ordinarily associated with a bank account of some type. A common type of debit card is the automated teller machine (“ATM”) type card. There are also other types of payment cards, such as stored value cards and smart cards. Each of these cards must generate a transaction record when a sales transaction occurs. Additionally, transaction data may be obtained from banking systems regarding cash deposits and withdrawals, including wire transfer systems, and the ACH system. A user of a payment system, including the credit card, debit card, checking, wire transfer, ACH, and cash deposit systems is referred to herein as a payor.

Credit card issuers and other payment system operators collect a large amount of payor data, some of which is obtained from payors directly. To apply for a credit card, for example, an applicant typically must supply demographic information (e.g. age, 15 city of residence), financial information (e.g., monthly expenses and bank account balance), and employment information (e.g., salary or length of employment). To determine whether to issue a card to the applicant, an issuer usually will contact a credit reporting agency to obtain the applicant's credit history.

Payment system operators also collect a great deal of information indirectly through the course of a transaction. Much of the indirectly obtained data is obtained through a merchant when the merchant obtains payment through the payment system. For example, when a payor makes a purchase, a payment system operator, such as a credit card issuer, obtains information about where the purchase was made (e.g., the store name and location), the purchase price, and the item or items purchased. The data collected by the operator can be used in a number of ways. For example, the purchase data may be used by credit card issuers to generate billing statements and collect payment from cardholders.

Credit card issuers may use cardholder information to offer additional products and services to the cardholder. Some issuers also utilize mailing lists including cardholder information for marketing purposes. However, use of a cardholder's personal data can create concerns over protecting consumer privacy. To remedy this, many issuers offer cardholders the option of removing their names from marketing lists.

The use of purchase data is even more fraught with privacy concerns, and most issuers have established policies against releasing data about purchases by individual consumers. Therefore, with the exception of obtaining payment, payment system operators, such as credit card issuers, may not make any use of personally identifiable information belonging to those payors who have requested to be removed from marketing lists. Therefore, there is a need in the art for systems that use aggregate payor information that is not personally identifiable to generate real-time market information predictions.

It is also possible to collect information about merchant sales transactions by examining information about check clearing transactions, wire transfers, ACH transfers and cash deposit records. For example, when a merchant decides whether to accept a check from a consumer, the merchant may use a check verification service. A check verification service provides an electronic database of persons who have written bad checks or have had their bank accounts closed as a result of bad check writing. Many merchants use such a service to determine whether a consumer has a history of writing bad checks and, in so doing, transmit sales transaction information to the databases of the check verification service provider.

In practice, many merchants run checks through an electronic reader or enter checking account numbers into terminals. The check verification service then approves or denies the check. Some check verification systems will deny a check if multiple checks have been written within a 24-hour period. Therefore, check verification services must keep a record about the check sales transactions conducted at particular merchants. However, there is no existing system that uses this type of information in a non-intrusive manner to provide real-time market information predictions.

Payment information is accumulated in check clearinghouse systems and similar banking systems. Once a check is deposited, it is routed from the check recipient's bank to the check writer's bank. During this process, the check is shipped to one of the regional Federal Reserve banks for clearance, and then sent back to the recipient's bank. There are other forms of automated checking clearinghouses and groups of banks that have agreed to a system of check exchange. Regardless how checks are cleared, however, payment information is accumulated and available for data processing nearly as quickly as the transactions occur. But there is a need in the art for systems and methods to use this vast amount of payment data to generate real-time market information predictions.

Some credit card issuers have existing methods of using credit card purchase data without compromising cardholder privacy. For instance, an Internet-based credit card issuer, NextCard.com, provides a monthly list of online merchants with the greatest number of online transactions by the their cardholders. The merchants are then ranked by the number of online transactions by the issuer's cardholders. This type of list is of limited utility, however, because it includes only purchases made over the Internet using the issuer's card, and provides only rankings, not actual sales data. Also, the list cannot be searched (e.g., to find information on a company that is not top-ranked) or sorted (e.g., by industry or product).

Other businesses use sales transaction information internally for forecasting purposes, e.g., to predict future sales or estimate product demand. For example, Renslo et al., U.S. Pat. No. 5,446,890, discloses a system in a manufacturing environment that uses order information to forecast future demand for products. By forecasting future demand, the system enables a manufacturer to increase or reduce parts in inventory and schedule production of those parts accordingly.

In Fields et al., U.S. Pat. No. 5,459,656, historical demand and actual current demand are used to predict future business demand for products or tasks. The projections can be used, for example, to update production plans on a regular basis. The models used for forecasting can account for a number of factors that effect demand for a product, including day of the week, season of the year, and promotional events.

Although systems such as these use actual sales data to predict future demand for products or services, they are limited in their usefulness. For example, these systems are limited to collecting sales data and forecasting future sales for a single product or business. They are not adapted to demonstrate industry-wide or nationwide trends or trends within a particular geographical region or a combination, such as, for example, southeastern automotive related company performance trends.

It is possible to compile sales figures for an entire industry or segment of the economy using some well-known reporting mechanisms. For instance, many companies report revenues quarterly, and consumer indicators, e.g. the Consumer Price Index, are typically released on a monthly basis. However, these known systems provide information about industries or segments of the economy slowly and only periodically.

Clearly, there is a need in the art for the ability to make near real-time market information predictions, including revenue trend predictions, based on payment transaction information.

### SUMMARY OF THE INVENTION

Systems and methods consistent with the principles of the invention provide near real-time market information predictions based on money flow maps derived from payment transaction information. Payment system operators, such as credit card issuers, have transactional data that is representative at a statistically significant level of general market trends of individual companies and broader econometric data, and payment system operators have access to transactional data on a real-time basis. The present invention meets the need for near real-time trend data by leveraging the transactional data. In one embodiment, the data can be manipulated to best fit corporate revenue trends, giving equity analysts more information on how a company is doing. More specifically, the embodiment can process the transactional data to produce revenue predictions for a company over the next month or quarter.

Therefore, the present invention will support the use of existing payment systems as well as new forms of electronic or smart cards or any other kind of payment system that generates essentially real-time transaction records.

Systems and method consistent with the principles of the invention also analyze transactional sales data. Transaction data is collected, the transaction data relating to a transaction between a payor and at least one of a plurality of payees. The collected transaction data is normalized to create normalized data. Normalized data is scaled to create financial information corresponding to a predetermined metric. The financial information is the provided to a user in a useful form.

Both the foregoing general description and the following detailed description are exemplary and are intended to provide further explanation of the invention as claimed.

### BRIEF DESCRIPTION OF THE DRAWINGS

The accompanying drawings provide a further understanding of the invention and are incorporated in and constitute a part of this specification. The drawings illustrate various embodiments of the invention, and, together with the description, serve to explain the principles of the invention. In the drawings:

FIG. 1A illustrates an embodiment of the system architecture of the present invention;

FIG. 1B is a block diagram showing an embodiment of the issuer system;

FIG. 1C is a flow chart depicting the features of one embodiment of the present invention;

FIG. 2A is a flow chart depicting an embodiment of collecting transactional data;

FIG. 2B is a flow chart depicting an embodiment of the authorization and posting process;

FIG. 2C illustrates an embodiment of the transactional data;

FIG. 3A is a flow chart depicting an embodiment of normalizing data based on total open accounts;

FIG. 3B is a flow chart depicting an embodiment of normalizing data based on total transactions;

FIG. 3C is a flow chart depicting an embodiment of normalizing data based on average outstanding balance;

FIG. 3D is a flow chart depicting an embodiment of normalizing data based on demographics;

FIG. 3E is an exemplary flow chart of a process for applying normalized data to calculate predicted performance;

FIG. 4A is a flow chart depicting an embodiment of scaling data using past normalized transactions;

FIG. 4B is a flow chart depicting an embodiment using a regression analysis to predict actual revenue;

FIG. 4C is a flow chart depicting an embodiment of scaling data using a neural network;

FIG. 4D is a flow chart depicting an embodiment of scaling data using past normalized transactions with underestimation;

FIG. 5A is a flow chart depicting an embodiment of applying data using a direct feed;

FIG. 5B is a flow chart depicting an embodiment of applying data using a query;

FIG. 5C is a flow chart depicting an embodiment of applying data by providing information to customers when real-time revenue projections vary from consensus estimates;

FIG. 5D is a flow chart depicting an embodiment of applying data using industry trends; and

FIG 5E is a flow chart depicting an embodiment of applying data using same store sales.

### DETAILED DESCRIPTION

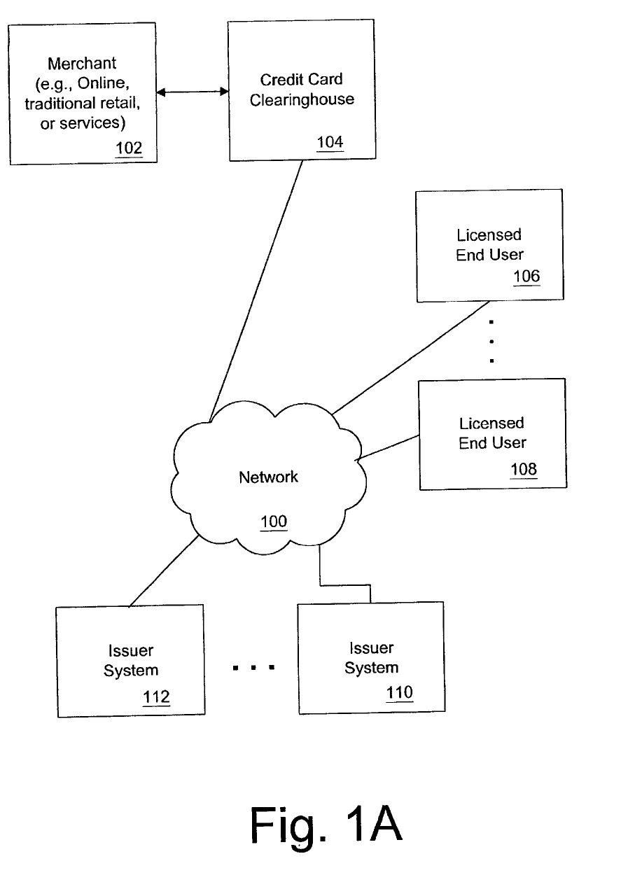

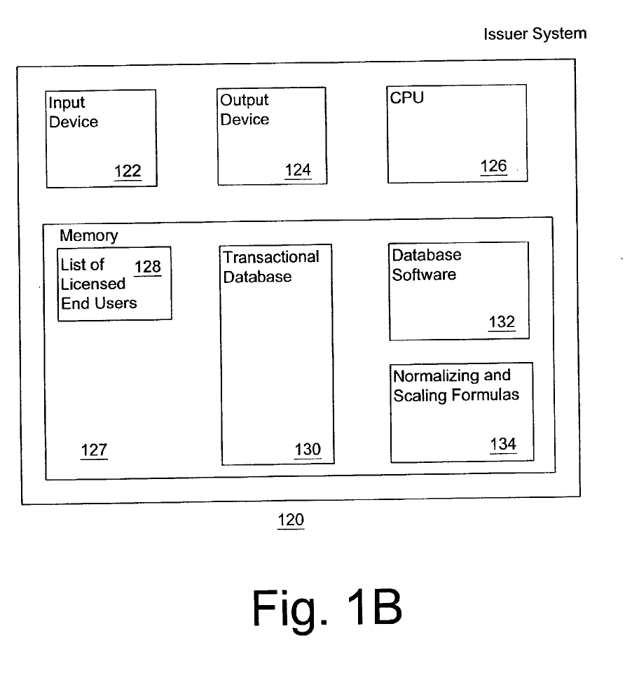

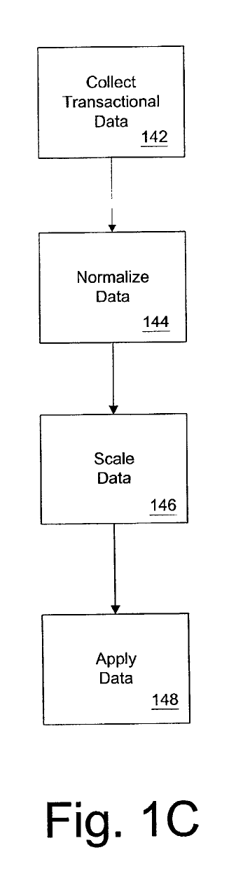

FIG. 1A illustrates an embodiment of the system architecture of the present invention. Network 100 may be any type of a network over which information may be exchanged. For example, network 100 may be the Internet, a private data network, or a virtual private network, using a public network such as the Internet. Network 100 may also include a public switched telephone network (PSTN) and/or a wireless network. Merchant 102 represents any number of merchants that provide goods or services in exchange for payment via a particular payment system. For example, merchant 102 may be: an online retail merchant, a traditional retail merchant, or any other type of merchant of goods or services. Each merchant 102 communicates directly to credit card clearinghouse 104 in order to initiate the process of obtaining payment. Credit card clearinghouse 104 may be, for example, the Visa or Master Card networks or a check clearing system.

In one embodiment, registered end users of issuer-aggregated information, such as, licensed end users 106 and 108 may access the information via network 100. As shown in FIG. 1A, there may be many licensed end users. In this embodiment, issuer aggregated information is collected and processed in issuer systems such as issuer systems 112 and 110, as further described in connection with FIG. 1B. There may be many such issuer systems, with each issuer system being implemented through any suitable combination of hardware, software and/or firmware.

FIG. 1B is a block diagram that illustrates an exemplary issuer system, consistent with the principles of the present invention. Issuer system 120 may be any sufficiently powerful general-purpose computing system. It may be, for example, a mainframe, a multi-processor UNIX system, or a powerful PC server system. In any case, such a system will have at least one input device, such as, input device 122. Possible input devices include: network interfaces, keyboards, mice, speech recognition devices, document, video, or image input devices, etc. Additionally, issuer system 120 contains at least one output device 124, such as, for example, display devices, network interfaces, printers, sound or speech output devices, etc.

As illustrated in FIG. 1B, issuer system 120 also includes at least one central processing unit (“CPU”) 126. CPU 126 is used to execute instructions that cause issuer system 120 to operate. Instructions and other data are stored in at least one memory 127 in issuer system 120. Also stored in memory 127 is a list of licensed end users 128. The list of licensed end users allows issuer system 120 to ensure that only properly licensed end users will be able to access issuer system 120. Transactional database 130 is also stored in memory 127. This database contains records known to issuer system 120. These transactions are processed by issuer system 120 in order to provide relevant data to licensed users in the list of licensed users 128. Additionally, issuer system 120 contains database software 132 that is used to manipulate transactional database 130. Normalizing and scaling formulas 134 are used by CPU 126 while executing instructions in conjunction with the database software to process the records in transactional database 130 and provide data in a form appropriate for transmission to licensed end users.

FIG. 1C is an exemplary flow chart depicting features for using transaction data, consistent with the principles of the present invention. This embodiment of the invention uses transaction data from cardholders to project corporate revenues for companies traded on any of the major exchanges (e.g., NYSE, NASDAQ, AMEX, etc.). The first step is to collect transactional data from merchants to whom payment is made by cardholders (step 142). This data is collected when a cardholder transacts at a merchant location using a Capital One or other major credit card, or any other kind of payment system that generates transactional information, including a check clearing system. The term cardholder is used as an example in conjunction with one embodiment. Nevertheless, it should be understood that in other payment systems, another term may be substituted for the term cardholder, and the present invention may be practiced in conjunction with transaction records generated in the course of a transaction by any payor, regardless of the term used to identify the payor.

After a cardholder makes a purchase, the transaction is delivered to the credit card issuer or other payment system operator, such as, for example, the Visa/MasterCard network or the check clearing system. For each company of interest, the dollar value of all transactions can be accumulated over a predetermined period of time, for example from the first day of current business quarter until the current day of business quarter.

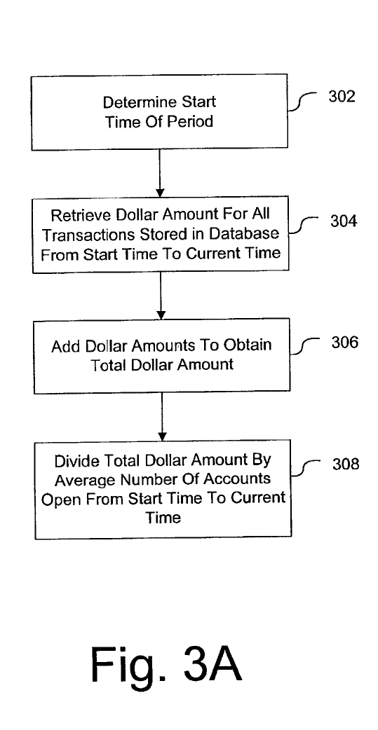

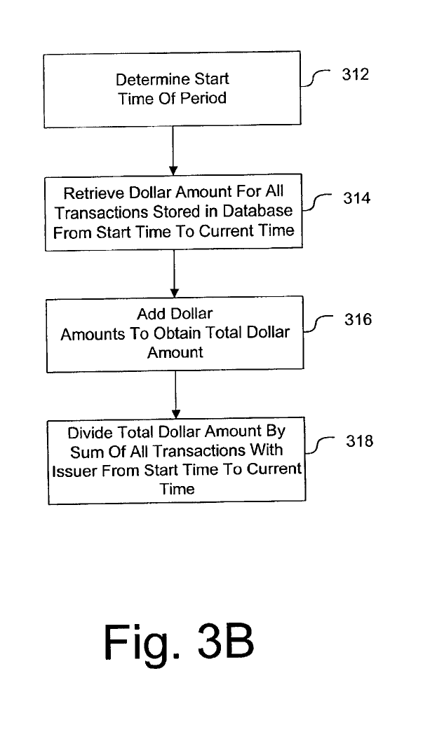

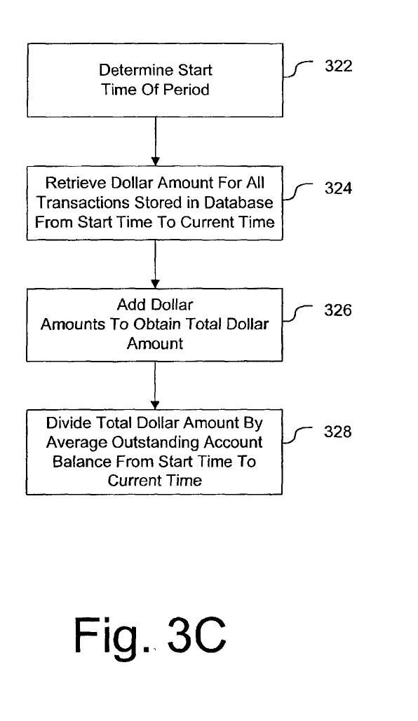

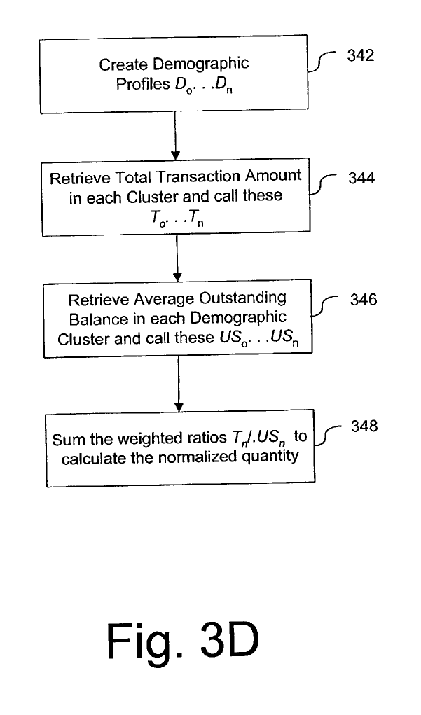

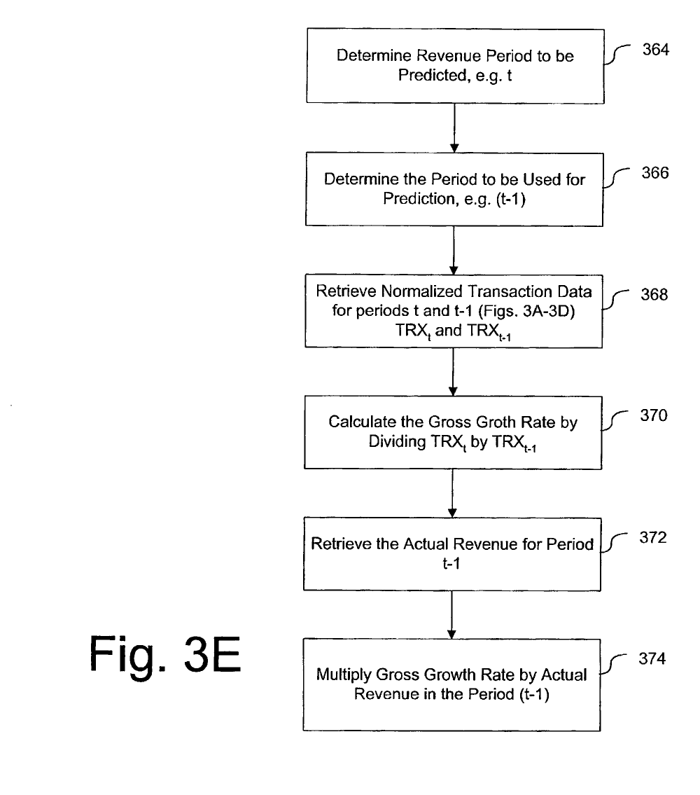

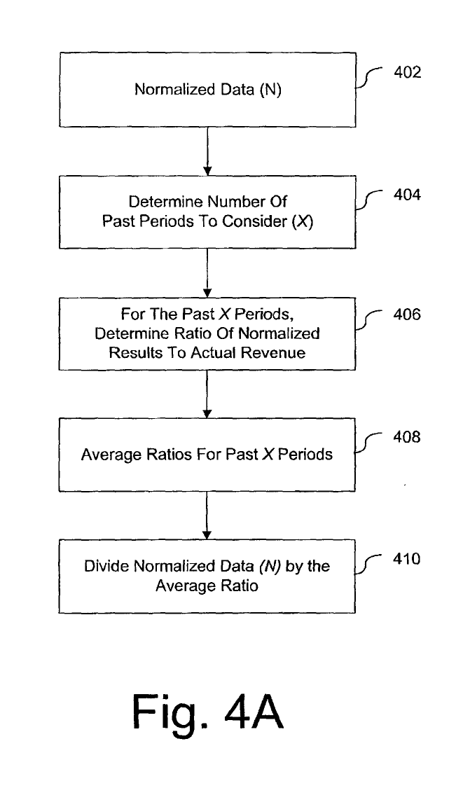

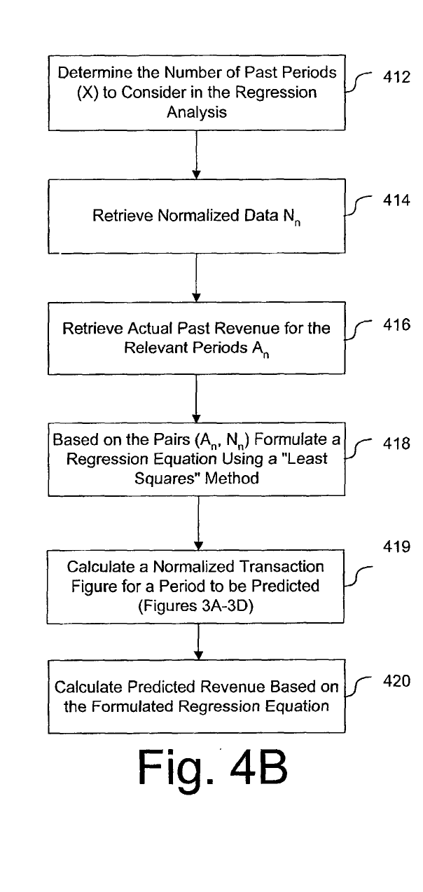

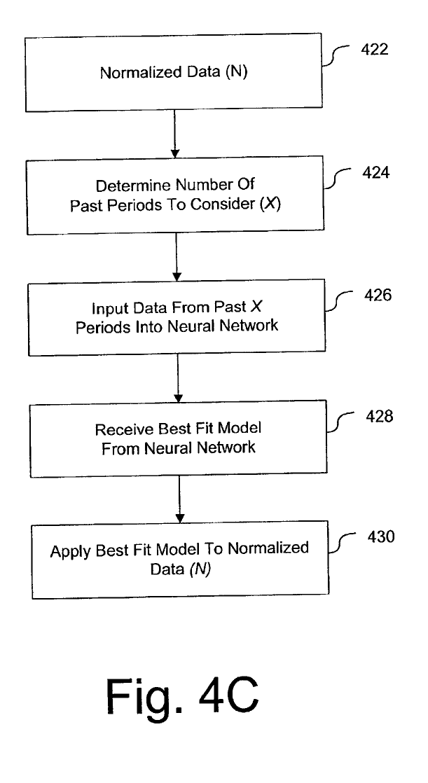

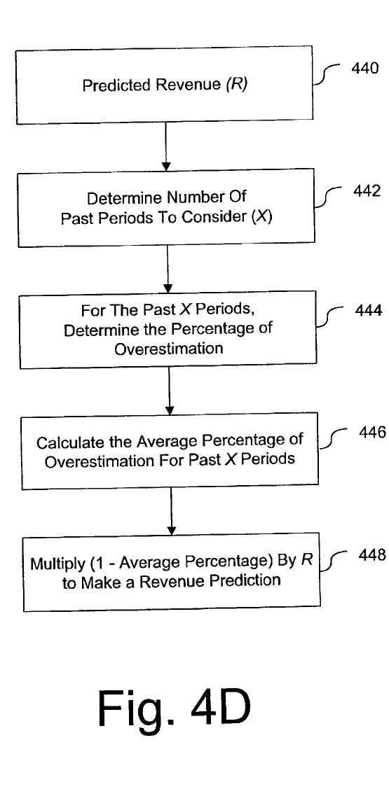

The accumulated transaction data is then processed by an issuer system. For example, the issuer system may normalize the data (step 144). Consistent with the principles of the present invention, normalization may be performed in a number of different ways, as further described in conjunction with FIGS. 3A-3E. After normalizing the data, the issuer system scales the data (step 146). As further described in connection with FIGS. 4A-4D (step 146), the normalized data may be scaled using a number of different techniques. For example, the scaling of data may be performed using linear regression or pattern recognition via a neural network.

Depending on the particular parameter, different scaling methods may be required to obtain a good prediction. For example, to predict corporate revenue trends, some information about a company's accounting practices may be necessary. An airline may, for example, obtain payment for a July flight in January, when a traveler plans her trip. However, the airline may not actually book the revenue until the ticket is used. Therefore, there may be some delay between the time when a payment transaction occurs and when the transaction is reflected in revenue.

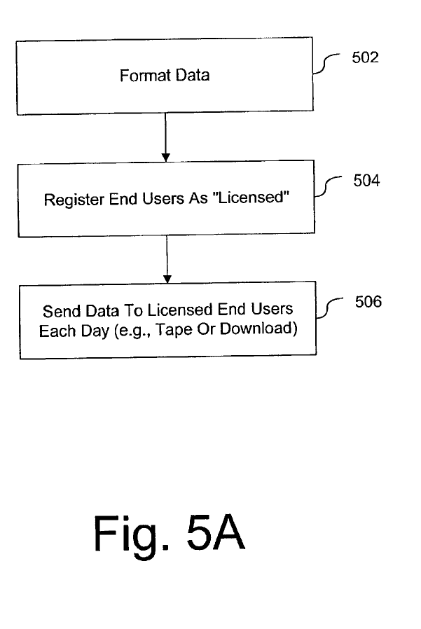

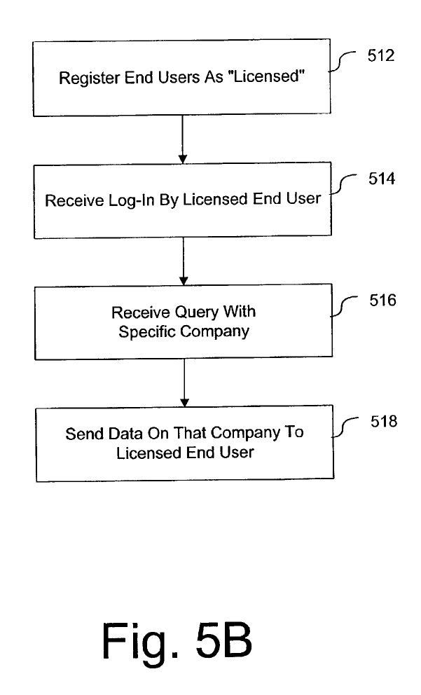

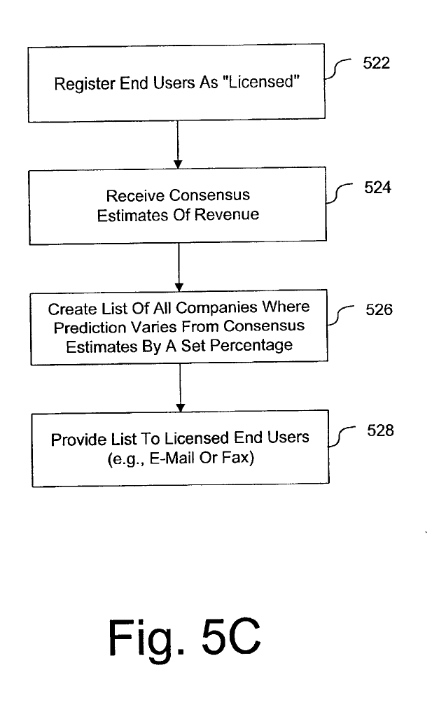

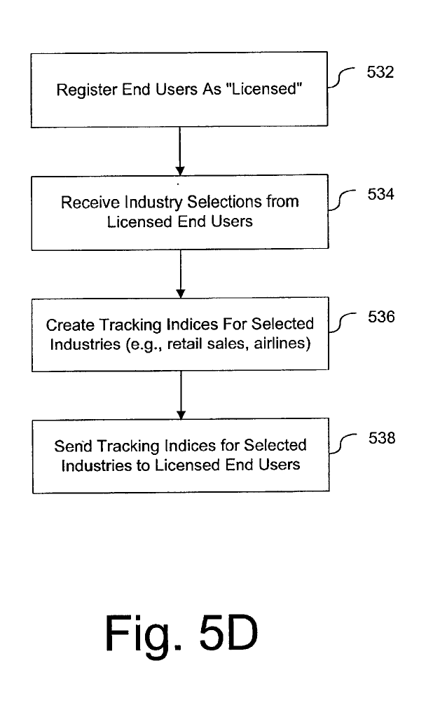

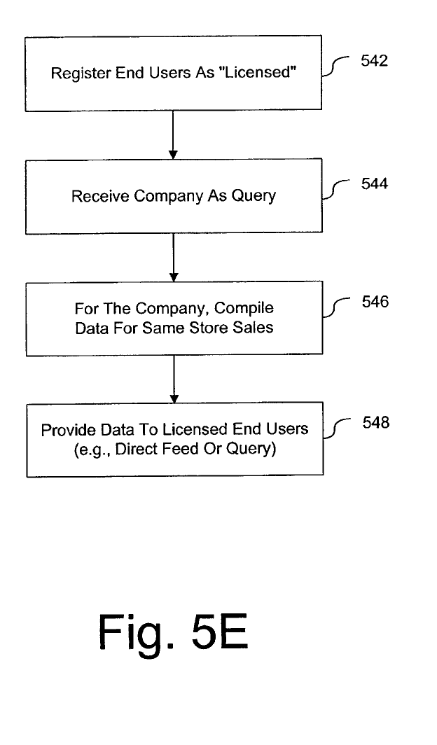

Finally, the issuer system applies the data to provide financial information to end users (step 148). As further described in connection with FIGS. 5A-5E, the manner in which the data is applied and presented to end users may vary. Step 148 may involve either providing the scaled and normalized sales information in its raw form or applying the scaled and normalized information to known or newly created models for predicting financial metrics, such as stock price, interest rates, or commodity supplies. One example is the application of sales information to predict a company stock performance. In another example, near real-time predictions may be made about stored supplies of a commodity (such as gasoline). Periodically, government agencies report information about aggregate stored supply levels of particular commodities. Thus, the last published report of commodity storage levels may be used in conjunction with normalized and scaled information about recent sales of the commodity to make near real-time predictions of the actual storage levels, before the next report becomes available. This may be done, for example, by taking an average price per gallon and calculating a number of gallons pumped based on the amount of money being transacted at merchants having, for example, a Standard Industrial Classification (“SIC”) number consistent with retail gasoline sales.

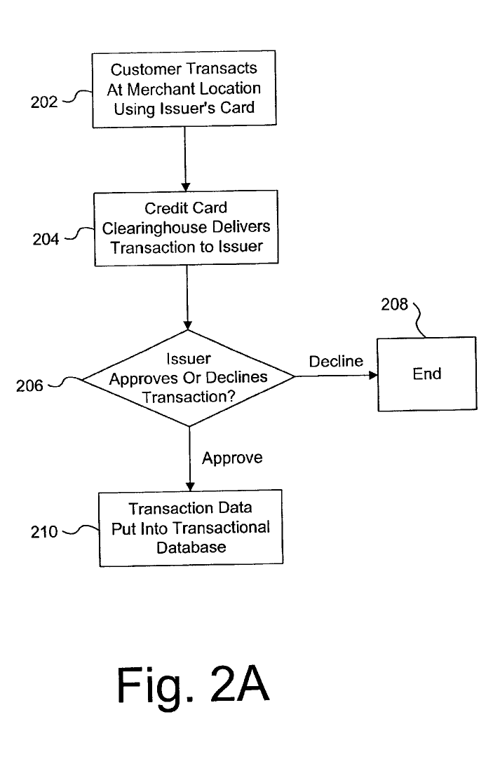

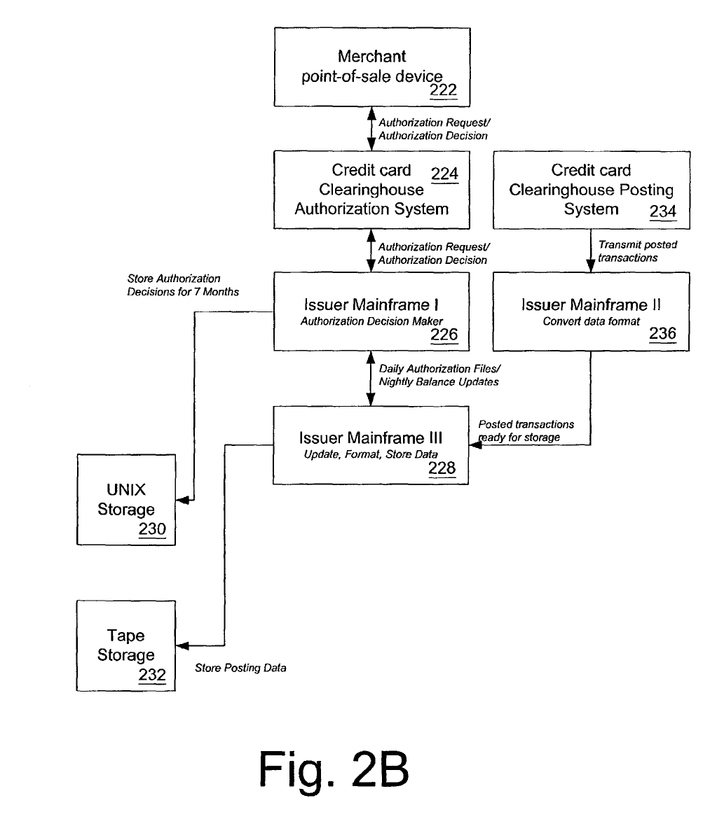

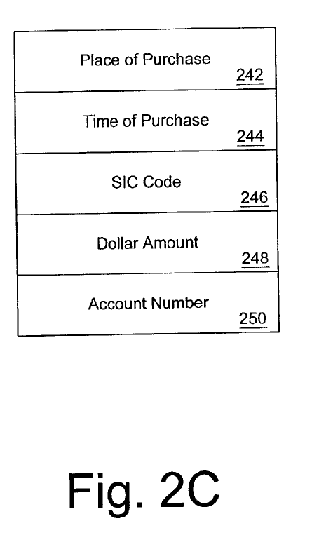

FIG. 2A is an exemplary flow chart depicting a process for collecting transactional data, consistent with the principles of the present invention In step 202, a customer transacts at a merchant location using a credit card issued by a credit card issuer. The merchant location may be a physical location (such as a “bricks-and-mortar” location) or may be a web site through which the merchant offers goods or services to customers. As part of the transaction, a merchant will collect payment information (e.g., a customer's credit card number) and compute a transaction total based on the goods and services selected by the customer. This transaction information is then forwarded to a corresponding credit card clearinghouse. The corresponding credit card clearinghouse then delivers information related to the transaction to the credit card issuer to seek authorization (step 204). Next, the issuer approves or declines the transaction based on the customer's status or credit (step 206). If the issuer approves the transaction, the transactional data is put into the transactional database (step 210). Otherwise, if the transaction is declined, the process terminates (step 208). Declined transactions may also be stored in the transactional database. Thereafter, the credit card issuer's decision concerning the transaction (approved or declined) is sent back to the merchant via the clearinghouse to permit the merchant to complete or terminate the attempted transaction with the customer.

FIG. 2B is an exemplary block diagram depicting an authorization and posting process, consistent with the principles of the present invention. During a transaction with a customer, merchant point-of-sale (“POS”) device 222 sends an authorization request to credit card clearinghouse system 224. The authorization request from merchant POS device 222 will result in an authorization decision from authorization system 224 once the authorization system 224 obtains authorization from issuer mainframe 226, which is the authorization decision maker. Issuer mainframe 226 uses known methods to determine whether a transaction should be authorized, including making sure that the card is not over its limit, verifying billing address information, and referencing lists of card numbers corresponding to lost or stolen cards. In order to obtain an authorization decision, authorization system 224 further transmits the authorization request to issuer mainframe 226. These authorization decisions may be stored in a UNIX-based storage device 230 for a period of time, such as, for example seven months. Daily authorization files and nightly account balance updates may be transmitted to issuer mainframe 228, which is used to update, format and store the data. In one embodiment, this is the data that is used as input to the scaling and normalizing processes Issuer mainframe 228 may store posting data in a tape storage device 232 for later retrieval or viewing.

In FIG. 2B, a credit card clearinghouse posting system 234 may be provided to transmit posted transactions to a second issuer mainframe 236, which is used to convert the posted transactions into a suitable data format for storage. The posted transactions that are converted by issuer mainframe 236 are transmitted to issuer mainframe 228, which stores the data to tape storage device 232.

FIG. 2C illustrates, consistent with the principles of the present invention, an example of the transactional data that may be stored sequentially by date. This data may include multiple fields. The first field is place of purchase 242. The second field is time of purchase 244. The third field is SIC code 246. The fourth field is dollar amount 248 corresponding to the amount of money that is to be exchanged in the transaction. The fifth field is account number 250, which corresponds to the account number of the transacting payor.

As described above, the normalization of transaction data (step 144 of FIG. 1C) may be performed in a number of different ways. Consistent with the principles of the present invention, FIGS. 3A-3E demonstrate different examples of the manner in which transaction data can be normalized.

FIG. 3A is an exemplary flow chart of a process for normalizing data based on total open accounts. The features of FIG. 3A may be performed by an issuer system. In step 302, the start time of the period over which the data will be normalized is determined This period may be a specific year, a quarter, or a month, for example, the first quarter of 1997, Jan. 1, 1997to Mar. 31, 1997. Next, the dollar amount for each transaction stored in the database is retrieved from the start time to the current time for a particular category (step 304). A particular category may correspond to, for example a specific merchant. Thereafter, the dollar amounts, of all transactions corresponding to a particular merchant, are added to produce a total dollar amount (step 306). If this total dollar amount is for a large on-line merchant, the total amount may be a number such as $1.4 million. Finally, the total is divided by the average number of accounts open during the period from the start time until the current time (step 309). This results in a dollar figure, normalized over the total number of open accounts, representing dollars transacted per open account.

FIG. 3B is an exemplary flow chart of a process for normalizing data based on total transactions. The features of FIG. 3B may be performed by an issuer system. The first step is to determine the start time for the period over which the data is to be normalized (step 312). Next, the dollar amount is retrieved for each transaction stored in the database from the start time to the current time (step 314). Next, the dollar amounts of all retrieved transactions are added to get the total amount transacted (step 316). Finally, the total amount is divided by the sum of the amount of all transactions with the issuer from the start time until the current time (step 318). This results in a dollar figure normalized over the total number of transactions, representing dollars transacted per transaction.

FIG. 3C is an exemplary flow chart of a process for normalizing data based on an average outstanding balance. The features of FIG. 3C may be performed by an issuer system. In step 322, the start time of the relevant period over which to normalize the data is determined. Next, the dollar amount is retrieved for all transactions stored in the database from the start time until the current time (step 324). Thereafter, the dollar amounts are added to produce a total dollar amount over the relevant time period (step 326). Next, the total dollar amount is divided by the average outstanding account balance from the start time to the current time (step 328). This process results in the total dollar figure normalized over the average outstanding balance, representing dollars transacted per dollar balance.

FIG. 3D is an exemplary flow chart of a process for normalizing data based on demographics. Predetermined demographic clusters are identified that uniquely describe particular categories of cardholders. For example, these categories may be associated with particular credit card services offered by an issuer to a group of consumers. Transactions can be summed for all known cardholders in each of these clusters and normalized by the number of active accounts or the number of transactions in each cluster. Because a credit card issuer will often maintain records indicating the amount of money transacted by each demographic cluster, the data can be normalized using these numbers as well.

In step 342 of FIG. 3D, one or more demographic profiles is created based on the predetermined demographic categories, and the profiles are labeled D₀ through Dₙ (step 342). Demographic profiles correspond to particular demographic criteria, such as, for example, household income. Demographic clusters are groups of consumers having a particular demographic profile. Next, the total transaction amount corresponding to each cluster is retrieved, labeling the total transaction amounts To through Tₙ, (step 344). Next, the average outstanding balance corresponding to each demographic cluster is retrieved, labeling the balance US₀ through USₙ, (step 346). Finally, the weighted ratios Tₙ/USₙ (for n=0 to the number of clusters) are summed to calculate the normalized quantity (step 348). The ratios may be weighted to indicate the relative sizes of each demographic cluster. Table 1 below contains illustrative values corresponding to a calculation made in connection with FIG. 3D.

TABLE 1

| | Demo- | Total | | | |
|---|---|---|---|---|---|
| | graphic | Transaction | Average | | |
| | Profile: | Amount: | Outstanding | Weight | Weighted |
| n | Dₙ | Tₙ | Balance | Factor | Ratio |
| 0 | Product A | 57,222.40 | 25,479,999,067 | 0.5 | 2.246 × 10⁻⁶ |
| 1 | Product B | 17,923.55 | 2,643,449,101 | 0.5 | 6.781 × 10⁻⁶ |

$$N = {w}_{0} \cdot \frac{{T}_{0}}{{US}_{0}} + {w}_{1} \cdot \frac{{T}_{1}}{{US}_{1}} = 0.5 \cdot 2.246 \cdot {10}^{- 6} + 0.5 \cdot 6.781 \cdot {10}^{- 6} = 4.51 \cdot {10}^{- 6} \qquad Equation 1$$

In equation 1, N is a normalized value that is calculated using demographic profiles.

FIG. 3E is an exemplary flow chart of a process for applying normalized data to calculate predicted performance. The features of FIG. 3E may be performed by an issuer system. First, a period for which to predict revenue for a company of interest is selected and the period is labeled “t” (step 364). Such a period may be, for example, Apr. 1, 2001 to Jun. 30, 2001. Next, a corresponding past period with known revenue is selected and labeled “t−1” (step 366). This period may be, for example, Jan. 1, 2000 to Mar. 31, 2000. Next, normalized transaction data is calculated as described in connection with any of FIGS. 3A-3D, labeling the normalized data TRXₜ and TRXₜ₋₁ (step 368). Next, the gross growth rate is calculated by dividing TRXₜ by TRXₜ₋₁ (step Once a gross growth rate has been determined, the actual revenue for period t−1 is obtained (step 372). Actual revenue may be obtained by services such as Standard & Poor's™. Finally, the actual revenue is multiplied by the gross growth rate to provide a revenue prediction (step 374).

A scale factor is useful for scaling normalized transaction data (N) to produce a prediction of monthly or quarterly corporate revenue. For example, to scale the data (step 146 of FIG. 1C), a historical ratio can be used that compares the normalized data to the actual reported revenue of a company. A number of different methods can be used to scale the normalized data, including the exemplary techniques described below with reference to FIGS. 4A-4D.

FIG. 4A is an exemplary flow chart of a process for scaling data using past normalized transactions. In step 402, the value N is calculated which corresponds to the result of normalizing the data by using, for example, any of the methods disclosed in connection with FIGS. 3A-3D. Next, the number of past periods X that will be considered is determined (step 404). Then, the ratio of normalized results to actual revenue for each of the past X periods is calculated (step 406). As described in connection with FIG. 3E, actual revenue figures may be obtained from known sources. Thereafter, the ratios for the past X periods are averaged to determine the average ratio of normalized transaction amounts to actual corporate revenue (step 408). Finally, N is divided by the average ratio to produce a revenue prediction (step 410).

FIG. 4B is a flow chart depicting an embodiment using a regression analysis to predict actual revenue. First, at step 412, a number X of past periods to consider in a regression analysis is determined. Next, the normalized data corresponding to the X periods is calculated by using, for example, any of the methods disclosed in connection with FIGS. 3A-3D (step 414). Then the actual revenue corresponding to the relevant past periods is obtained using known means (step 416). Next, based on the normalized data and the actual revenue figures, a regression equation is formulated using, for example, a “least squares” method (step 418). Next, a normalized transaction figure is calculated corresponding to a period for which revenue is to be predicted, using any of the methods described in connection with FIGS. 3A-3D (step 419). Finally, predicted revenue is calculated based on the formulated regression equation (step 420).

FIG. 4C is an exemplary flow chart of a process for scaling data using a neural network. First, at step 422, the value N is calculated which corresponds to the result of normalizing the data by using, for example, any of the methods disclosed in connection with FIGS. 3A-3D. Next, the number of past periods X to be considered is determined (step 424). Next, data from the past X periods is provided as input to a known neural network capable of matching patterns corresponding to metrics, such as, for example, accurate revenue prediction (step 426). Thereafter, a best fit model is derived from the neural network (step 428). A best-fit model may be selected on the basis of the model's ability to accurately predict past performance as is evident to persons skilled in the art. Finally, the best fit model is applied to normalization data N to calculate a prediction (step 430).

FIG. 4D is an exemplary flow chart of a process for scaling revenue predictions, correcting for overestimation. First, at step 440, a value R is calculated, which corresponds to a revenue prediction made using methods consistent with the present invention. Next, the number of past periods X to be considered is determined (step 442). Next, for each of the past X periods, a percentage by which revenue was over-estimated is calculated (step 444). The over-estimation calculation may be done by comparing the predicted revenue with actual revenue figures obtained form known sources. Thereafter, the average of the percentage of overestimation for the past X periods is computed (step 446). Finally, the figure (1-the average percentage of over estimation) is multiplied by R to compute a scaled revenue prediction (step 448).

Illustrative embodiments have been described in connection with the prediction of corporate revenue using input data, such as, for example credit cardholder transaction information. Persons of ordinary skill in the art will appreciate that other types of econometric figures may be predicted without departing from the scope of the invention as claimed, and other inputs may be substituted for credit cardholder transaction data, consistent with the present invention.

As described above, after the transaction data is normalized and scaled, the data is applied to provide financial information to end users (step 148 of FIG. 1C). Consistent with the principles of the present invention, transaction data may be applied and presented in a number of ways. In the following examples, access and retrieval of the data can be performed through a private network (such as a PBX, virtual private network or intranet) and/or a public network (such as a PSTN, public wireless network, or the Internet).

In one embodiment, predictions may be generated about the direction of large-scale consumer-oriented econometrics. Some examples include consumer spending, Gross Domestic Product, and the money supply M1.

In another alternative embodiment, normalized and scaled transactional data for a particular merchant may be used to generate a credit score for the particular merchant, indicating the merchant's creditworthiness. This is accomplished by comparing past revenue for the merchant with the predicted revenue, predicted by normalizing and scaling transactional information for the merchant. The credit scores may be provided to potential creditors in exchange for a fee. The credit scoring services may be marketed directly to potential creditors by the operator of the payment system or alternatively by an entity in the existing credit scoring industry.

In yet another alternative embodiment, sales information regarding demographic trends may be marketed to merchants. For example, a retail merchant may have targeted a particular demographic profile in its advertising and marketing initiatives. The retail merchant is likely be extremely interested to learn whether there was an associated increase in spending among the targeted demographic segment of the consuming public. Therefore, near real-time predictions about the actual spending among a particular demographic profile may be extremely valuable to retailers.

FIGS. 5A-5E illustrate further examples of different techniques for applying and presenting data to end users, consistent with the principles of the present invention. The features of FIGS. 5A-5E may implemented in a number of system environments, including the exemplary system environment of FIG. 1 in which licensed end users 106-108 receive financial information from one or more issuer systems 110-112 via a network 100.

In the examples of FIGS. 5A-5E, licensed end users may register with an issuer system to receive financial information in exchange for agreeing to follow certain licensing terms (e.g., restrictions on dissemination or copying of financial information, payment of license fees, etc.). If the licensing terms require a license fee, payment from licensed end users may be obtained in several forms. For example, a user may obtain unlimited accesses to financial information from an issuer system for a yearly license fee. Alternatively, an end user may pay on a per company or index basis. In certain cases, a user may obtain a discounted price for data for which access is delayed by a predetermined period. Other license fee payment structures are also possible. For example, a user may wish to obtain unlimited access in exchange for the issuer receiving a percentage of the licensed customer's profit, revenue or managed assets. An end user may pay a flat fee for customized reports or an end user may pay for customized reports, billing for data analysts' and system time on a cost plus basis.

FIG. 5A is an exemplary flow chart of a process for applying data using a direct feed. In step 502, the data is formatted by an issuer system. Some examples of formatting data consistent with the present invention include placing the data into spreadsheet format, such as for example the Excel™ spreadsheet available from Microsoft™. Next, end users that agree to the licensing terms of the issuer system are registered as “licensed” (step 504). This step may be performed using an on-line registration process or other registration methods known in the art. During the registration process, basic contact information (e.g., name, mailing address, email address) and/or billing information (e.g., credit card or account number) may be received from an end user. Thereafter, each end user that is registered with the issuer system is sent the formatted financial information on a periodic basis (e.g., daily or weekly) using a designated or preferred delivery method (e.g., on a computer readable medium, such as a compact disk (CD) or tape, or by downloading the information over a network) (step 506).

FIG. 5B is an exemplary flow chart of a process of applying data using a query. In step 512, an end user registers as a “licensed” end user with an issuer system (step 512). Once again, this step may be performed using an on-line registration process or other registration methods known in the art. Next, a log-in by a licensed end user is received via a web site hosted by the issuer system (step 514). During a log-in, the end user may enter a unique combination of information (e.g., username and password) to gain access to the issuer system. After successfully logging into the issuer system, the licensed end user submits a query for financial data about a specific company (step 516). The data may be accessed and received in real time through a user interface, or a remote database engine interface, such as, for example a structured query language (“SQL”). For example, licensed customers may type in a company name to access real-time predictions about the company. Following step 516, data regarding that company is located and sent to the licensed end user (step 518). This information may include historical revenue trends as well as revenue predictions and the issuer's confidence in the prediction. Additionally, the information may include recent news releases, historical earnings trends, filed SEC documents, financial ratings, and consensus estimates.

FIG. 5C is an exemplary flow chart of a process for applying data by providing information to customers when real-time revenue projections vary from consensus estimates. In step 512, an end user registers as a “licensed” end user with an issuer system (step 522). Next, consensus estimates of revenue are received from various known sources of such information (step 524). Then, a list is created of all companies where the real-time revenue prediction varies from consensus estimates by a set percentage (step 526). This step may be performed by identifying where financial experts disagree by a predetermined threshold amount. Next, the generated list is provided to licensed end users by various possible means, including email or facsimile via a network (step 528). After the end user receives the information, he or she may connect to the issuer's system to further examine the list and download additional financial information.

FIG. 5D is an exemplary flow chart of a process for applying data using industry trends. Tracking indices for specialized industries can be created using the predicted revenue data. Examples of industries include retail sales, transportation, airlines, mail order, Internet, etc. Tracking indices could be faxed or emailed to “licensed customers” or they could log onto the issuer's system to examine the indices. In step 532, an end user registers as a “licensed”user with an issuer system (step 532). As described above, this step may be performed using an on-line registration process or other registration methods known in the art. Next, industry selections are received from a licensed end user (step 534). This step may be performed by collecting selections via a web page or by other communication means. Based on the selections made by the end user, tracking indices are created for each of the selected industries (e.g. retail sales, airlines etc) (step 536). Next, tracking indices are computed and sent to licensed end users for the selected industries (step 538). Various communication methods may be used to perform this step, including email, facsimile and/or downloading via a network.

FIG. 5E is an exemplary flow chart of a process for applying data using same store sales. In step 542, an end user registers as a “licensed” user with an issuer system (step 532). Next, a company query is received from a licensed end user (step 544). Then, the issuer system compiles same store sales for the requested company (step 546). Next, the compiled data is provided to licensed end users through, for example, a direct feed or use of real time queries of views on a database server (step 548).

Methods and systems consistent with the principles of the present invention may be used within a consortium model in which multiple issuers join together to form a consortium. Capital One™ or a major credit card issuer could license similar data from other sources, including other credit card companies, Visa, MasterCard, American Express, Discover, retail cards, gas cards or any other issuer in an automated payment system), pooling the data into a consortium database to improve sample size and accuracy of predictions. This same concept may be used to predict earnings, stock price, economic indices, industry indices, interest rates, and sector trends.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

We claim:

1. A method for analyzing sales transaction data corresponding to sales transactions carried out between a plurality of payors and a plurality of merchants, the method comprising:
collecting sales transaction data, the sales transaction data relating to a transaction between a payor and at least one of the plurality of merchants;
normalizing the collected sales transaction data from the plurality of payors to create normalized data;
scaling the normalized data to create financial information corresponding to a predetermined metric; and
providing the financial information to a user.

2. The method of claim 1, wherein the financial information is used to make predictions about general econometric parameters.

3. The method of claim 1, wherein the financial information is used to make predictions about actual supplies of commodities.

4. The method of claim 1, wherein the financial information is used to make revenue predictions for one of the plurality of merchants.

5. The method of claim 1, wherein the financial information is used to make earnings predictions for one of the plurality of merchants.

6. The method of claim 1, wherein the financial information is used to make stock-price predictions for one of the plurality of merchants.

7. The method of claim 1, wherein the financial information is used to predict interest rates.

8. The method of claim 1, wherein the financial information comprises a credit score indicating the creditworthiness of a merchant, and wherein the providing the financial information to a user further comprises:
providing the credit score to a potential creditor of the merchant.

9. The method of claim 1, wherein the normalizing further comprises:
processing the collected data based on a total number of payors utilizing the services of the payment system operator.

10. The method of claim 1, wherein the normalizing further comprises:
processing the collected data based on a total dollar amount of outstanding transactions owed to a creditor within the payment system.

11. The method of claim 1, wherein the normalizing further comprises:
processing the collected data based on a total number of transactions by payors using the payment system.

12. The method of claim 1, wherein the normalizing further comprises:
processing the collected data based on demographic information of payors using the payment system.

13. The method of claim 1, wherein the normalizing further comprises:
processing the collected data based on historical revenue of the merchant.

14. The method of claim 13, wherein the financial information comprises a credit score indicating the creditworthiness of a merchant, and wherein the providing the financial information to a user further comprises:
providing the credit score to a potential creditor of the merchant.

15. The method of claim 1, wherein the scaling further comprises:
applying a linear regression analysis to the normalized data.

16. The method of claim 1, wherein the scaling further comprises:
applying a neural network analysis to the normalized data.

17. The method of claim 16, wherein the applying a neural network analysis to the normalized data further comprises:
applying pattern recognition within the neural network analysis.

18. A method for providing financial information to a user based on transactions between a plurality of payors and a plurality of merchants, the method comprising:
registering the user as a licensed user;
collecting data when each payor uses a payment system to transact with at least one of the plurality of merchants;
analyzing the collected data to generate financial information; and
providing the financial information to the licensed user.

19. The method of claim 18, wherein the financial information is used to make predictions about general econometric parameters.

20. The method of claim 18, wherein the financial information is used to make predictions about actual supplies of commodities.

21. The method of claim 18, wherein the financial information is used to make revenue predictions for the at least one merchant.

22. The method of claim 18, wherein the financial information is used to make earnings predictions for the at least one merchant.

23. The method of claim 18, wherein the financial information is used to make stock-price predictions for the at least one merchant.

24. The method of claim 18, wherein the financial information is used to predict interest rates.

25. The method of claim 18, wherein the financial information comprises a credit score indicating the creditworthiness of the at least one merchant, and wherein the providing the financial information to the licensed user further comprises:
providing the credit score to a potential creditor of the at least one merchant.

26. The method of claim 18, wherein the analyzing further comprises:
processing the collected data based on a total number of payors utilizing the services of a payment system operator.

27. The method of claim 18, wherein the analyzing further comprises:
processing the collected data based on a total dollar amount of outstanding transactions owed to a creditor within the payment system.

28. The method of claim 18, wherein the analyzing further comprises:
processing the collected data based on a total number of transactions by payors using the payment system.

29. The method of claim 18, wherein the analyzing further comprises:
processing the collected data based on demographic information of payors using the payment system.

30. The method of claim 18, wherein the analyzing further comprises:
processing the collected data based on historical revenue of the merchant.

31. The method of claim 30, wherein the financial information comprises a credit score indicating the creditworthiness of a merchant, and wherein the providing the financial information to a user further comprises:
providing the credit score to a potential creditor of the merchant.

32. The method of claim 18, wherein the registering further comprises:
receiving a user preference indicating how the user prefers to receive the financial information.

33. The method of claim 18, wherein the providing further comprises:
sending the financial information to the licensed user via a direct data feed.

34. The method of claim 18, wherein the providing further comprises:
sending the financial information to the licensed user via electronic mail.

35. The method of claim 18, wherein the providing further comprises:
making the information available to the licensed user via the Internet.

36. The method of claim 18, wherein the providing further comprises:
making the information available to the licensed user via conventional mail or courier.

37. The method of claim 18, wherein the providing further comprises:
making the information available to the licensed user via facsimile.

38. A computer-readable medium containing instructions for causing a computer to perform a method for analyzing sales transaction data corresponding to sales transactions carried out between a plurality of payors and a plurality of merchants, the method comprising:
collecting sales transaction data, the sales transaction data relating to a transaction between a payor and at least one of the plurality of merchants;
normalizing the collected sales transaction data from the plurality of payors to create normalized data;
scaling the normalized data to create financial information corresponding to a predetermined metric; and
providing the financial information to a user.

39. A computer-readable medium according to claim 38, wherein the financial information is used to make predictions about general econometric parameters.

40. A computer-readable medium according to claim 38, wherein the financial information is used to make predictions about actual supplies of commodities.

41. A computer-readable medium according to claim 38, wherein the financial information is used to make revenue predictions for one of the plurality of merchants.

42. A computer-readable medium according to claim 38, wherein the financial information is used to make earnings predictions for one of the plurality of merchants.

43. A computer-readable medium according to claim 38, wherein the financial information is used to make stock-price predictions for one of the plurality of merchants.

44. A computer-readable medium according to claim 38, wherein the financial information is used to predict interest rates.

45. A computer-readable medium according to claim 38, wherein the financial information comprises a credit score indicating the creditworthiness of a merchant, and wherein the providing the financial information to a user further comprises:
providing the credit score to a potential creditor of the merchant.

46. A computer-readable medium according to claim 38, wherein the normalizing further comprises:
processing the collected data based on a total number of payors utilizing the services of the payment system operator.

47. A computer-readable medium according to claim 38, wherein the normalizing further comprises:
processing the collected data based on a total dollar amount of outstanding transactions owed to a creditor within the payment system.

48. A computer-readable medium according to claim 38, wherein the normalizing further comprises:
processing the collected data based on a total number of transactions by payors using the payment system.

49. A computer-readable medium according to claim 38, wherein the normalizing further comprises:
processing the collected data based on demographic information of payors using the payment system.

50. A computer-readable medium according to claim 38, wherein the normalizing further comprises:
processing the collected data based on historical revenue of the merchant.

51. A computer-readable medium according to claim 50, wherein the financial information comprises a credit score indicating the creditworthiness of a merchant, and wherein the providing the financial information to a user further comprises:
providing the credit score to a potential creditor of the merchant.

52. A computer-readable medium according to claim 38, wherein the scaling further comprises:
applying a linear regression analysis to the normalized data.

53. A computer-readable medium according to claim 38, wherein the scaling further comprises:
applying a neural network analysis to the normalized data.

54. A computer-readable medium according to claim 53, wherein the applying a neural network analysis to the normalized data further comprises:
applying pattern recognition within the neural network analysis.

55. A computer-readable medium containing instructions for causing a computer to perform a method for providing financial information to a user based on transactions between a plurality of payors and a plurality of merchants, the method comprising:
registering the user as a licensed user;
collecting data when each payor uses a payment system to transact with at least one of the plurality of merchants;
analyzing the collected data to generate financial information; and
providing the financial information to the licensed user.

56. A computer-readable medium according to claim 55, wherein the financial information is used to make predictions about general econometric parameters.

57. A computer-readable medium according to claim 55, wherein the financial information is used to make predictions about actual supplies of commodities.

58. A computer-readable medium according to claim 55, wherein the financial information is used to make revenue predictions for the at least one merchant.

59. A computer-readable medium according to claim 55, wherein the financial information is used to make earnings predictions for the at least one merchant.

60. A computer-readable medium according to claim 55, wherein the financial information is used to make stock-price predictions for the at least one merchant.

61. A computer-readable medium according to claim 55, wherein the financial information is used to predict interest rates.

62. A computer-readable medium according to claim 55, wherein the financial information comprises a credit score indicating the creditworthiness of the at least one merchant, and wherein the providing the financial information to the licensed user further comprises:
providing the credit score to a potential creditor of the at least one merchant.

63. A computer-readable medium according to claim 55, wherein the analyzing further comprises:
processing the collected data based on a total number of payors utilizing the services of a payment system operator.

64. A computer-readable medium according to claim 55, wherein the analyzing further comprises:
processing the collected data based on a total dollar amount of outstanding transactions owed to a creditor within the payment system.

65. A computer-readable medium according to claim 55, wherein the analyzing further comprises:
processing the collected data based on a total number of transactions by payors using the payment system.

66. A computer-readable medium according to claim 55, wherein the analyzing further comprises:
processing the collected data based on demographic information of payors using the payment system.

67. A computer-readable medium according to claim 55, wherein the analyzing further comprises:
processing the collected data based on historical revenue of the merchant.

68. A computer-readable medium according to claim 67, wherein the financial information comprises a credit score indicating the creditworthiness of a merchant, and wherein the providing the financial information to a user further comprises:
providing the credit score to a potential creditor of the merchant.

69. A computer-readable medium according to claim 55, wherein the registering further comprises:
receiving a user preference indicating how the user prefers to receive the financial information.

70. A computer-readable medium according to claim 55, wherein the providing further comprises:
sending the financial information to the licensed user via a direct data feed.

71. A computer-readable medium according to claim 55, wherein the providing further comprises:
sending the financial information to the licensed user via electronic mail.

72. A computer-readable medium according to claim 55, wherein the providing further comprises:
making the information available to the licensed user via the Internet.

73. A computer-readable medium according to claim 55, wherein the providing further comprises:
making the information available to the licensed user via conventional mail or courier.

74. A computer-readable medium according to claim 55, wherein the providing further comprises:
making the information available to the licensed user via facsimile.

75. A system for analyzing sales transaction data corresponding to sales transactions carried out between a plurality of payors and a plurality of merchants, the apparatus comprising:
a processing unit;
an input/output device coupled to the processing unit;
a storage device in communication with the processing unit, the storage device including,
program code for collecting sales transaction data, the sales transaction data relating to a transaction between a payor and at least one of the plurality of merchants;
program code for normalizing the collected sales transaction data from the plurality of payors to create normalized data;
program code for scaling the normalized data to create financial information corresponding to a predetermined metric; and
program code for providing the financial information to a user.

76. The system of claim 75, wherein the financial information is used to make predictions about general econometric parameters.

77. The system of claim 75, wherein the financial information is used to make predictions about actual supplies of commodities.

78. The system of claim 75, wherein the financial information is used to make revenue predictions for one of the plurality of merchants.

79. The system of claim 75, wherein the financial information is used to make earnings predictions for one of the plurality of merchants.

80. The system of claim 75, wherein the financial information is used to make stock-price predictions for one of the plurality of merchants.

81. The system of claim 75, wherein the financial information is used to predict interest rates.

82. The system of claim 75, wherein the financial information comprises a credit score indicating the creditworthiness of a merchant, and wherein the program code for providing the financial information to a user further comprises:
program code for providing the credit score to a potential creditor of the merchant.

83. The system of claim 75, wherein the program code for normalizing further comprises:
program code for processing the collected data based on a total number of payors utilizing the services of the payment system operator.

84. The system of claim 75, wherein the program code for normalizing further comprises:
program code for processing the collected data based on a total dollar amount of outstanding transactions owed to a creditor within the payment system.

85. The system of claim 75, wherein the program code for normalizing further comprises:
program code for processing the collected data based on a total number of transactions by payors using the payment system.

86. The system of claim 75, wherein the program code for normalizing further comprises:
program code for processing the collected data based on demographic information of payors using the payment system.

87. The system of claim 75, wherein the program code for normalizing further comprises:
program code for processing the collected data based on historical revenue of the merchant.

88. The system of claim 87, wherein the financial information comprises a credit score indicating the creditworthiness of a merchant, and wherein the program code for providing the financial information to a user further comprises:
program code for providing the credit score to a potential creditor of the merchant.

89. The system of claim 75, wherein the program code for scaling further comprises:
program code for applying a linear regression analysis to the normalized data.

90. The system of claim 75, wherein the program code for scaling further comprises:
applying a neural network analysis to the normalized data.

91. The system of claim 90, wherein the program code for applying a neural network analysis to the normalized data further comprises:
program code for applying pattern recognition within the neural network analysis.

92. A method comprising:
collecting credit card transaction records corresponding to transactions between a plurality of cardholders and a plurality of merchants;
normalizing the collected credit card records to create normalized sales data;
scaling the normalized sales data to create scaled sales data;
applying an econometric model to the scaled sales data to generate financial information corresponding to the econometric model; and
providing the financial information to a user.

93. The method of claim 92, wherein the step of applying an econometric model to the scaled sales data further comprises the step of:
applying a revenue prediction model to the scaled sales data to generate a revenue prediction for a merchant in the plurality of merchants.

94. The method of claim 92, wherein the generated financial information comprises a credit score indicating the creditworthiness of a merchant in the plurality of merchants, and wherein the step of providing the financial information to a user further comprises:
providing the credit score to a potential creditor of the merchant.

95. A computer system adapted to provide financial information to a user, the computer system having a processing unit capable of executing program code, and the computer system comprising:
an input/output device coupled to the processing unit;
a storage device in communication with the processing unit, the storage device including,
program code for collecting credit card transaction records corresponding to transactions between a plurality of cardholders and a plurality of merchants;
program code for normalizing the collected credit card records to create normalized sales data;
program code for scaling the normalized sales data to create scaled sales data;
program code for applying an econometric model to the scaled sales data to generate financial information corresponding to the econometric model; and
program code for providing the financial information to a user.

96. A computer system according to claim 95, wherein the program code for applying an econometric model to the scaled sales data further comprises:
program code for applying a revenue prediction model to the scaled sales data to generate a revenue prediction for a merchant in the plurality of merchants.

97. A computer system according to claim 95, wherein the generated financial information comprises a credit score indicating the creditworthiness of a merchant in the plurality of merchants, and wherein the program code for providing the financial information to a user further comprises:
program code for providing the credit score to a potential creditor of the merchant.
